(19) United States
(12) Patent Application Publication
(10) Pub. No.: US 2025/0337276 A1
(43) Pub. Date: Oct. 30, 2025

(54) WIRELESS CHARGER AND FURNITURE COMPONENT INCLUDING THE SAME

(71) Applicant: The Lovesac Company, Stamford, CT (US)

(72) Inventors: Shawn D. Nelson, Washington, UT (US); David M. Underwood, Hurricane, UT (US); Stephen Ciccarelli, St. George, UT (US); Jacob D. Forman, Washington, UT (US); Joel Hyrum Bennett, Morgan, UT (US)

(21) Appl. No.: 18/800,622

(22) Filed: Aug. 12, 2024

Related U.S. Application Data
(63) Continuation-in-part of application No. 29/957,123, filed on Aug. 12, 2024.
(63) Continuation-in-part of application No. 29/940,035, filed on Apr. 30, 2024.

(51) Int. Cl. H02J 50/00; A47B 21/06; A47C 7/72; A47C 21/00; H02J 50/10

(52) U.S. Cl. CPC H02J 50/005; A47B 21/06; A47C 7/72; A47C 21/003; H02J 50/10; A47B 2021/066

(57) ABSTRACT

A furniture component includes a body having an internal side disposed opposite an external side. Each of the internal side and the external side extends along a length between a first side and a second side. A bottom side of the furniture component is disposed opposite a top side. Each of the first side and the second side extends along a height between the bottom side and the top side. A region hidden is in the body and configured to receive an electronic device, such as a wireless charger. A flap covers the at least one region.

### CROSS-REFERENCE TO RELATED APPLICATIONS

The present application claims priority to U.S. Design application No. 29/940,035, entitled “Furniture” and filed on Apr. 30, 2024, and to U.S. Design application No. 29/957,123, entitled “Charger” and filed on Aug. 12, 2024. Each of these applications is incorporated by reference in its entirety herein.

### TECHNICAL FIELD

The present disclosure relates generally to a charging system and more particularly to a wireless charging system configured for deployment in a hidden region, such as within furniture.

### BACKGROUND

Wireless-capable devices brought about the desire for seamless integration of technology into living and working spaces. Wireless charging allows users to simply place their devices on designated spots to initiate charging. However, many wireless charging systems involve cables and other components to supply power from a power source to the wireless charger that clutter surfaces.

### SUMMARY

Implementations described and claimed herein address the foregoing by providing wireless charging systems and methods. In some implementations, a furniture component includes a body having an internal side disposed opposite an external side. Each of the internal side and the external side extends along a length between a first side and a second side. A bottom side of the furniture component is disposed opposite a top side. Each of the first side and the second side extends along a height between the bottom side and the top side. A region hidden is in the body and configured to receive an electronic device, such as a wireless charger. A flap covers the at least one region.

In some implementations, the wireless charger includes a coil operable to wirelessly transfer energy to a device to charge the device. A printed circuit board (PCB) is electrically coupled with the coil. A housing includes a coil portion configured to receive the coil and a PCB portion configured to receive the PCB. The coil portion includes one or more intake vents through which air flows into the housing. The PCB portion includes one or more exhaust vents through which the air flows out of the housing. The coil portion and the PCB portion are in fluid communication so that the air flows from the intake vents, across the coil in the coil portion, across the PCB in the PCB portion, and out of the one or more exhaust vents.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1A is a front view of an example furniture assembly.

FIG. 1B is a perspective view of an example furniture component.

FIG. 2A is a front view of another example furniture assembly.

FIG. 2B is a perspective view of an example furniture component.

FIG. 3A is a top perspective view of a furniture component with a top flap partially lifted.

FIG. 3B is a partially exploded view of the furniture component with an example wireless charger.

FIG. 3C is a perspective view of an example filler.

FIG. 4A is a perspective view of the wireless charger.

FIG. 4B is a diagram of the wireless charger.

FIG. 4C is a bottom, right perspective view of the wireless charger.

FIG. 4D is a bottom, front perspective view of the wireless charger.

FIG. 4E is a bottom, left perspective view of the wireless charger.

FIG. 5 is a cross-sectional view of the furniture component with the wireless charger.

FIG. 6 is a bottom perspective, partial cross-sectional view of the furniture component.

FIG. 7A is a top, front perspective view of the furniture component with a straight side, omitting the top flap.

FIG. 7B is a rear perspective view of the furniture component.

FIG. 7C is a bottom, front perspective view of the furniture component.

FIG. 8A is a top, front perspective view of a furniture component, omitting the top flap;

FIG. 8B is a rear perspective view of the furniture component.

FIG. 8C is a bottom, front perspective view of the furniture component.

FIG. 9A is a diagram of the wireless charger, showing air flow therethrough.

FIG. 9B is a diagram of a body of a furniture component, showing air flow therethrough.

### DETAILED DESCRIPTION

Aspects of the presently disclosed technology relate to systems and methods for wireless charging. In some aspects, a wireless charger is receivable into a region. The region may be one of a plurality of regions hidden in a system, such as a furniture assembly. The furniture assembly may include, without limitation, a sofa, a seat, a chair, a bed, a table, a bench, a stool, a recliner, and/or other furniture. In some examples, the furniture assembly is a modular furniture assembly with a plurality of modular furniture components that may be connected with each other in various orientations and manners to form different furniture configurations. For example, a furniture assembly may include one or more seats, one or more sides, and one or more cushions. The seat(s) may include a base and be configured to connect with the side(s). Each of the side(s) may be configured to be positioned in one of a plurality of orientations to connect with the seat(s) in various manners. For example, each side may have an inner surface that can connect with a first side of the base in a first orientation, a second side of the base in a second orientation, and a third side of the base in a third orientation. In this manner, each side may be configured as a right arm, a left arm, and/or a back of a softa in one example of a furniture assembly.

In some aspects, each side may include a plurality of regions hidden near an edge (e.g., top, bottom, etc.) of the side. The regions are positioned with respect to each other and the side, such that the regions are accessible independent of an orientation of the side (e.g., as a left arm, right arm, back, etc.). For example, the plurality of regions may include a first region, a second region, and a third region spaced across a length of the side. In addition to being orientation agnostic, the plurality of regions provides users with multiple locations to choose from for housing devices, such as a wireless charger, speakers, temperature control elements (e.g., heating/cooling surfaces), lighting elements, and/or the like. These multiple locations further facilitate repair and replacement to extend the life of the underlying components and systems. Additionally, the regions are configured to provide a uniform feeling across a surface of the side, such that a user has a comfortable and uninterrupted experience in interacting with and touching the side. The hidden regions may be easily accessed from a top, underside, etc. (e.g., using a flap) further enhancing a user experience.

The various systems and methods disclosed herein generally provide for one or more hidden regions configured to receive various devices, such as wireless charging systems, independent of an orientation of an underlying component (e.g., furniture side). The hidden regions are disposed such that they are orientation agnostic relative to a configuration of the underlying system. The hidden regions are further configured to increase airflow and cooling for the devices disposed therein. The present disclosure provides examples with respect to furniture assemblies including modular furniture components. It will be appreciated by those skilled in the art, however, that the wireless charging system may be applicable to hidden regions of various systems.

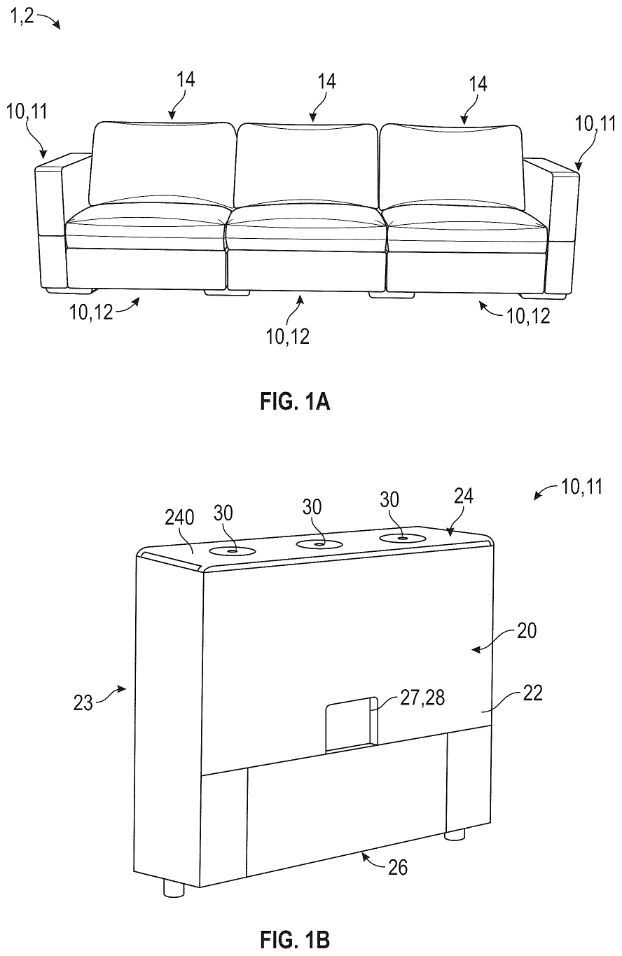

To begin a detailed description of wireless charging systems and methods, reference is made to FIG. 1A. In some implementations, an example furniture assembly 1 includes a region 30 for wireless charging a device, for example a phone, a tablet, wearable, electronic devices, batteries, and/or the like. For example, as illustrated in FIG. 1A, a sofa 2 includes a plurality of furniture components 10 which can be assembled together in various manners to form the furniture assembly 1. The furniture components 10 can include one or more bases 12, a plurality of cushions 14, and at least one side (e.g., arm 11). The base(s) 12 can be operable to support a person sitting and/or laying on top thereof. The cushions 14 can be positioned on top of the base(s) 12, and the arm 11 can be positioned on opposing sides of the base(s) 12. The arm 11 can extend vertically from the base(s) 12, and in some examples, can be coupled with the base(s) 12. While the disclosure discusses one non-limiting example of the furniture assembly 1 being a three-seat sofa, it will be appreciated that the present technology applies to other furniture assemblies and other systems.

In some examples, the furniture assembly 1 can be modular, such that a plurality of different furniture components 10 can be mixed, matched, exchanged, and/or rearranged to form the furniture assembly 1. The furniture components 10 can be detachably coupled with one another to form the furniture assembly 1. In some examples, the furniture assembly 1 may not be modular, and the furniture components 10 are meant to be detached once coupled with one another.

Referring to FIG. 1B, the furniture component 10 can include the arm 11. The arm 11 can include a body 20. The body 20 can be configured to form the shape and size of the furniture component 10. As illustrated in FIG. 1B, the arm 11 can be substantially rectangular such that the arm 11 includes an internal side 22, an external side 23 opposite the internal side 22, a bottom side 26, and a top side 24 opposite the bottom side 26. The top side 24 and the bottom side 26 can span between the internal side 22 and the external side 23. The top side 24 and the bottom side 26 can be substantially parallel while the internal side 22 and the external side 23 can be substantially parallel. The internal side 22 can be operable to be coupled with, abut against, and/or extend from the base 12. The external side 23 can face outwards from the furniture assembly 1.

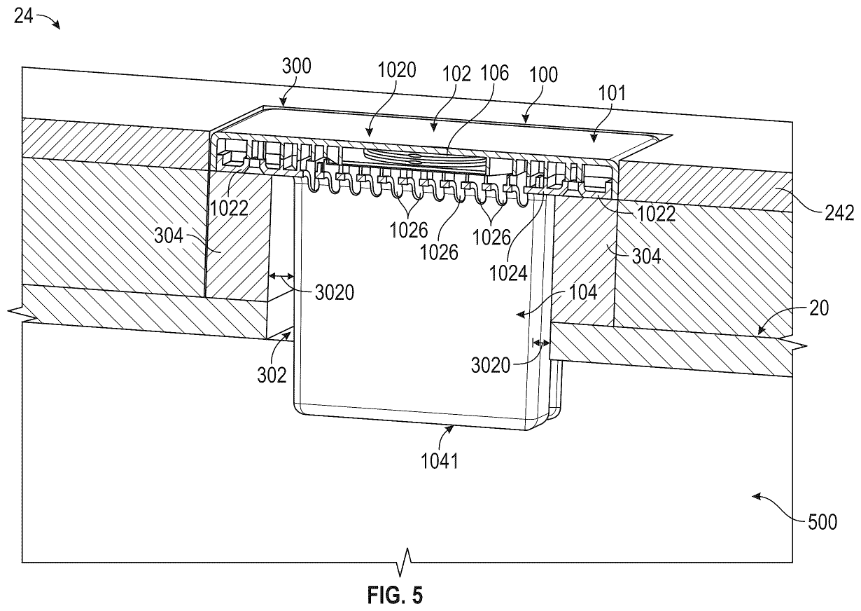

In at least one example, the body 20 can form one or more access holes 27 that are open external to the body 20. The access holes 27 can be in fluid communication with a cavity 500 (as shown in FIGS. 5, 6, and 9B) of the body 20. For example, the internal side 22 can include one or more of the access holes 27. As illustrated in FIG. 1B, the access holes 27 can include one or more clamp holes 28. The clamp hole 28 can be operable to assist in coupling the arm 11 with another furniture component 10. In at least one example, the clamp hole 28 can be operable to receive a clamp (not illustrated) that is partially inserted into the clamp hole 28 and partially inserted into a clamp hole for another furniture component 10, thus coupling the two furniture components 10 together. Other mechanisms for coupling furniture components 10 can be utilized without deviating from the scope of the disclosure.

In at least one example, as illustrated in FIG. 1B, the furniture component 10 can be operable to provide wireless charging when the device is placed on the top side 24. In at least one example, the top side 24 can include regions 30 on which the device should be placed to be wirelessly charged. In some examples, the regions 30 can be marked on a top flap 240 of the top side 24. In some examples, the regions 30 are not marked. In some examples, the region 30 can be positioned on other surfaces of the furniture component 10. As illustrated in FIG. 1B, the furniture component 10 can include a plurality of regions 30 substantially equally spaced about the top side 24. By having a plurality of regions 30, the device can be wirelessly charged on the top side 24 at a convenient spot for the user. For example, with the arm 11, the device can be wirelessly charged closer to the back, closer to the edge, and/or in the middle. Any combination of regions 30 can be utilized for wireless charging. In some examples, only one region 30 can provide wireless charging at a time. In some examples, any of the plurality of regions 30 can provide wireless charging. In some examples, the furniture component 10 may include only one region 30 for wireless charging.

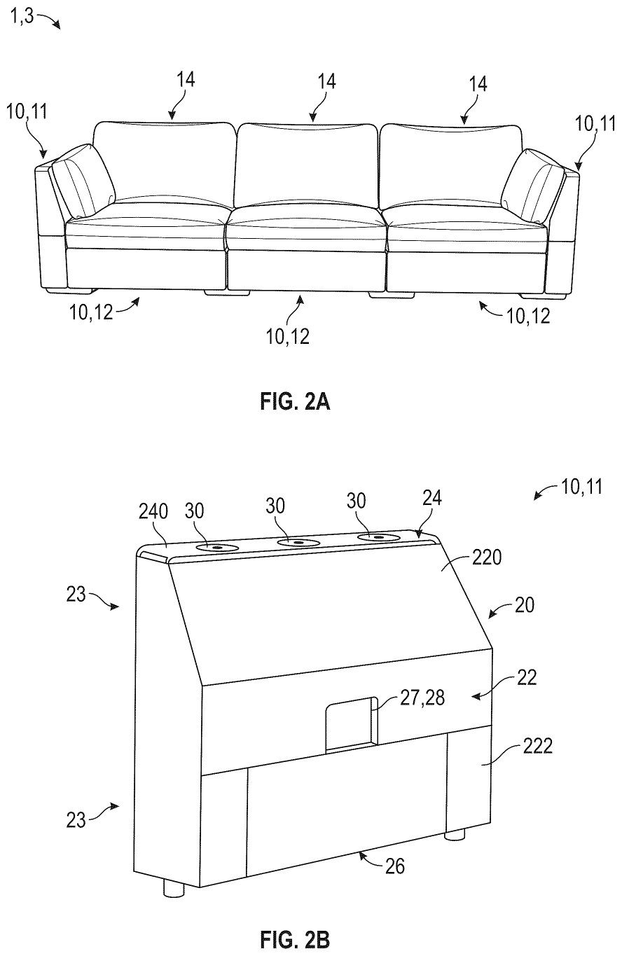

In some examples, as illustrated in FIGS. 2A and 2B, the furniture component 10 (e.g., the arm 11) can have different configurations, shapes, and/or sizes without deviating from the scope of the disclosure. As illustrated in FIGS. 2A and 2B, the arm 11 can include an angled internal side 22. For example, the internal side 22 can include a parallel portion 222 that is substantially parallel with the external side 23, and an angled portion 220 that extends from the parallel portion 222 to the top side 24 at an angle. Accordingly, the bottom side 26 may have a width that is greater than the top side 24.

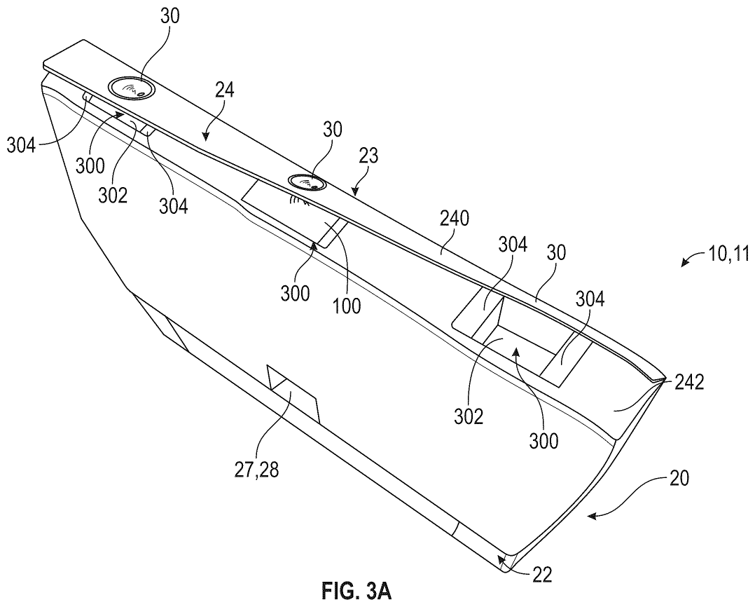

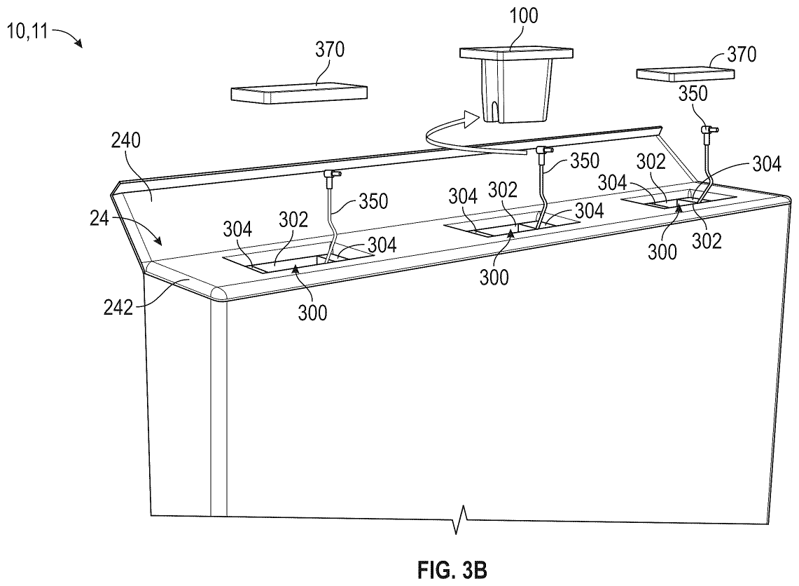

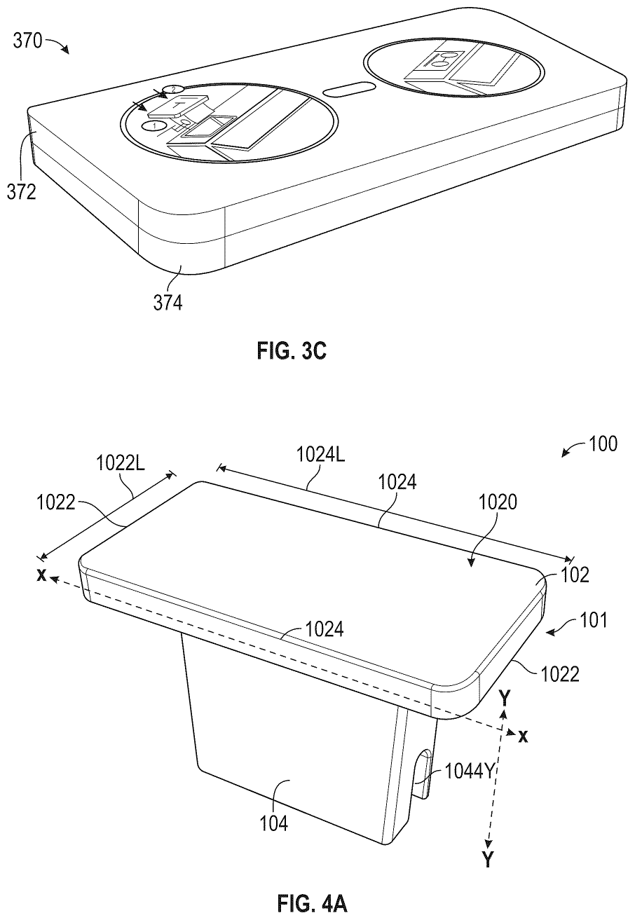

FIGS. 3A and 3B illustrate the top flap 240 being lifted to expose the regions 30 for wireless charging and the components underneath the top flap 240 that are operable to provide the wireless charging capabilities of the furniture component 10. The top flap 240 can be operable to cover one or more receiving components 300 and one or more corresponding wireless chargers 100. In some examples, the top flap 240 can be separable from the body 20 to reveal the one or more receiving components 300 and the wireless charger(s) 100. For example, the top flap 240 can be coupled with the body 20 via zipper, Velcro, magnet(s), snap(s), and/or any other suitable coupling mechanism to be able to detachably couple the top flap 240 with the body 20. In some examples, the top flap 240 may be permanently coupled with the body 20 on one side while detachable from an opposing side, as illustrated herein. In some examples, the top flap 240 may be fully detachable from the body 20. In some examples, the top flap 240 can be water-resistant to protect the wireless charger(s) 100 and/or any other components contained within the body 20 from water damage.

In at least one example, the body 20 of the furniture component 10 can include one or more receiving components 300 that correspond with the region(s) 30 that can provide wireless charging. As illustrated in FIGS. 3A and 3B, the furniture component 10 can include three receiving components 300. Each of the receiving components 300 can be operable to receive a wireless charger 100 which can be operable to provide wireless charging when the device is placed within a predetermined distance from the wireless charger 100. A wireless charger 100 can be received in any combination of receiving components 300. For example, as illustrated herein, only one wireless charger 100 may be included in the furniture component 10. The wireless charger 100, as illustrated herein, is received in the center receiving component 300. However, in some examples, all of the receiving components 300 may have a wireless charger 100 received therein. In some examples, two wireless chargers 100 can be received in corresponding receiving components 300 as desired (e.g., one in the center receiving component 300 and one in the receiving component 300 positioned away from the back of the furniture component 10).

In at least one example, the wireless charger(s) 100 can be removably received in the receiving component 300 such that the wireless charger 100 can be replaced and/or moved to a different receiving component 300. Accordingly, the furniture component 10 is further modular in terms of desired region(s) 30 for wireless charging. Additionally, if the wireless charger 100 is broken, the wireless charger 100 can be easily removed and replaced, so that the furniture component 10 does not need to be wholly replaced, or the entire furniture assembly 1 be wholly replaced just to have wireless charging again, or the furniture assembly 1 just does not have wireless charging anymore. To remove, move, and/or replace the wireless charger 100, the top flap 240 simply needs to be lifted to reveal the wireless charger 100. The wireless charger 100 can then be accessed to be removed, moved, and/or replaced. While the disclosure discusses the wireless charger 100 being accessed from the top side of the furniture component 10, in some examples, the wireless charger 100 can be accessed, removed, moved, and/or replaced from underneath the wireless charger 100 (e.g., from the inner side 22).

In at least one example, each receiving component 300 can include an aperture 302 and one or more supports 304 that are proximate to the aperture 302. The aperture 302 can be in fluid communication with the cavity 500 (as shown in FIGS. 5, 6, and 9B) of the body 20.

FIGS. 3A and 3B illustrate that the receiving component 300 includes two supports 304 on opposing sides of the aperture 302. In other examples, the receiving component 300 may include only one support 304 proximate to the aperture 302. In some examples, the receiving component 300 may include three, four, or more supports 304 provided about the aperture 302. In some examples, the aperture 302 is centrally positioned between the supports 304. This can provide even support for the wireless charger 100 when the wireless charger 100 is received in the receiving component 300. In other examples, the aperture 302 may be positioned at other locations within the receiving component 300.

The top side 24 can include a cushion 242 which provides comfort to the user. The cushion 242 can include, but are not limited to, foam, down, feathers, latex, cotton, wool, recycled materials, fibers, hulls, and/or hybrid materials.

The supports 304 can be recessed from the top side 24 such that when the wireless charger 100 is received in the receiving component 300, the wireless charger 100 does not extend from the top side 24 to provide a seamless design and experience for the user. Accordingly, when the wireless charger 100 is received in the receiving component 300, the wireless charger 100 can be flush with the cushion 242 of the top side 24.

In some examples, the receiving component(s) 300 that do not include a wireless charger 100 can be operable to receive a filler 370 in place of the wireless charger 100. The filler 370 can be operable to provide a similar feel as the cushion 242 of the top side 24. Accordingly, the user would not be able to obviously feel a difference in the receiving component(s) 300 that receive the filler 370. In at least one example, as illustrated in FIG. 3C, the filler 370 can include a first layer 372 and a second layer 374 positioned underneath the first layer 372. The first layer 372 can include foam (or the material that matches the cushion 242 of the top side 24) to provide cushioning. The second layer 374 can include nylon, or any other suitable material, to create structural support that spans the aperture 302 of the receiving component 300 and does not collapse and/or move.

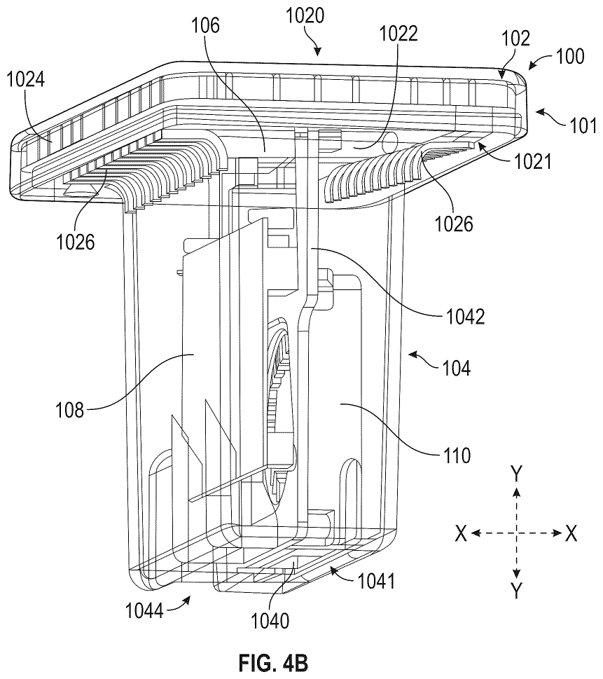

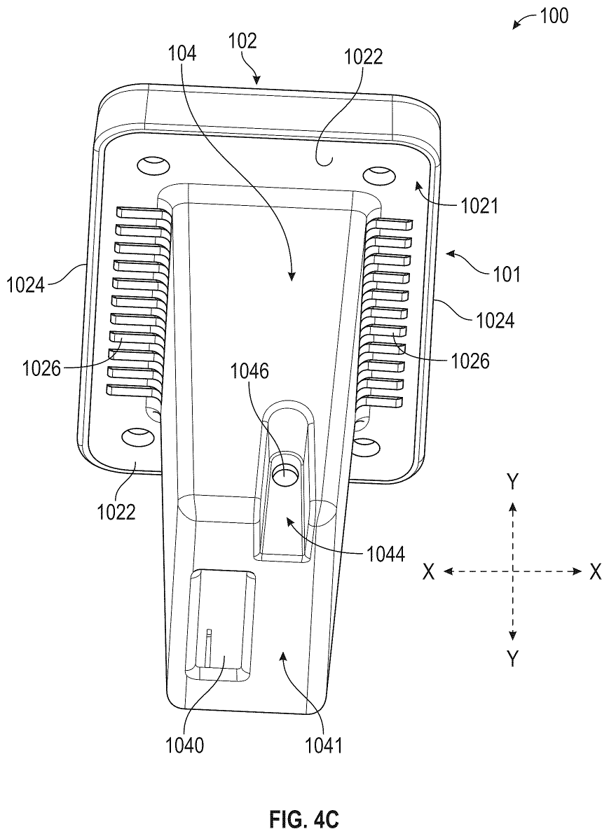

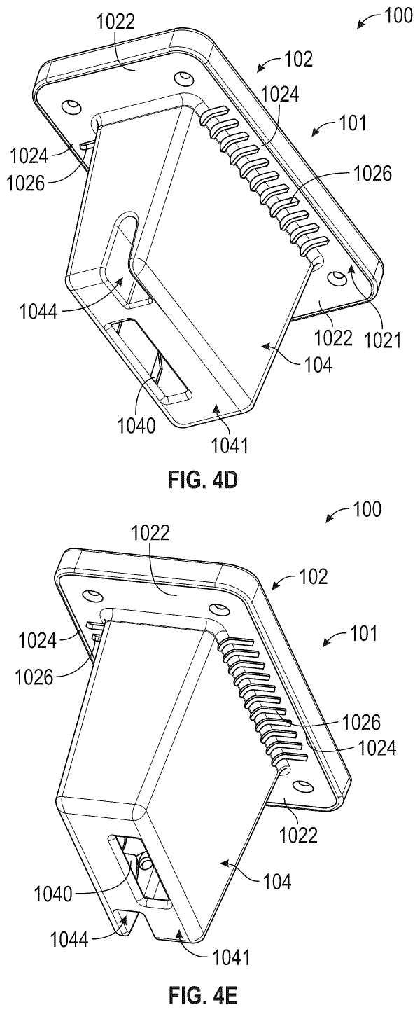

A power source 350 can be coupled with the wireless charger 100 and provide power to the wireless charger 100. For example, the power source 350 can be plugged into a power receptor 1046 of the wireless charger 100 (shown, for example, in FIG. 4C). In some examples, the power source 350 can be received in the body 20. In some examples, the power source 350 can be accessed via the aperture 302 of the receiving component 300 such that the wireless charger 100 can be easily installed. In some examples, the power source 350 can include a battery. In some examples, the power source 350 can be detachably coupled with another power source (e.g., an outlet or a power point.

FIGS. 4A-4E illustrate the wireless charger 100. The wireless charger 100 includes a coil 106 operable to wirelessly transfer energy to a device to charge the device. For example, the wireless charger 100 and the coil 106 can provide wireless charging through electromagnetic induction. The coil 106 can be operable to generate an alternating magnetic field when connected to the power source 350. When the device with a receiver coil (e.g., built into the device or added via a case) is placed on the wireless charger 100, the magnetic field induces an electric current in the receiver coil, which charges the device's battery wirelessly. The wireless charger 100 can include a printed circuit board (PCB) 108 that is electrically coupled with the coil 106. The PCB 108 can be operable to control the coil 106 and the generation of the magnetic field based on the power received from the power source 350.

A fan 110 can be operable to draw air into the housing 101 (e.g., into the intake vents 1026) and dispel the air out of the housing 101 (e.g., out from the exhaust vent(s) 1041). In at least one example, the fan 110 can be included in the wireless charger 100 which can provide easier replacement of the wireless charger 100 by the user. In some examples, a fan 110 can be disposed within the cavity 500 (as shown in FIGS. 5, 6, and 9B) of the furniture component 10 which can be operable to circulate air into and/or out of the cavity 500. However, in such an example, the fan 110 may not be as easily accessible to the user for replacement and/or repair if needed.

The wireless charger 100 includes a housing 101 that houses the coil 106 and the PCB 108. The housing 101 includes a coil portion 102 configured to receive the coil 106 and a PCB portion 104 configured to receive the PCB 108.

In some examples, the PCB portion 104 can include a power recess 1044 which is in communication with the power receptor 1046 for the wireless charger 101. The power recess 1044 is operable to at least partially receive the power source 350 (e.g., a plug and/or a cable).

The housing 101 includes one or more intake vents 1026 through which air flows into the housing 101. The housing 101 also includes one or more exhaust vents 1041 through which the air flows out of the housing 101.

In some examples, the coil portion 102 can include the intake vents 1026. The coil portion 1026 can include at least one side portion 1024. The at least one side portion 1024 can extend outward from the PCB portion 104 along the first plane X. For example, as illustrated in FIGS. 4B-4E, the coil portion 102 includes two side portions 1024 that extend on opposing sides of the PCB portion 104. In some examples, the side portions 1024 can overhang from the PCB portion 104. The side portions 1024 can form the intake vents 1026, for example underneath the coil portion 102. When the intake vents 1026 are formed underneath the side portions 1024, the air can flow from underneath the coil portion 102 so that the intake vents 1026 are not blocked by fabric when the device is placed onto the coil portion 102 of the housing 101. In some examples, the intake vents 1026 can span from the side portions 1024 of the coil portion 102 into the PCB portion 104. The shape, orientation, and/or size of the intake vents 1026 can vary without deviating from the scope of the disclosure.

In some examples, the PCB portion 104 can include the one or more exhaust vents 1041. As illustrated in FIGS. 4B-4E, the housing 101 includes one exhaust vent 1041. In other examples, the housing 101 can include a plurality of exhaust vents 1041. As illustrated in FIGS. 4B-4E, the exhaust vent 1041 can be formed in a bottom surface 1040 of the PCB portion 104. The bottom surface 1040 can be on an opposing side of the PCB portion 104 from the coil portion 102. In other words, the bottom surface 1040 can be opposite the coil portion 102. Accordingly, the exhaust vent 1041 is positioned away from the intake vents 1026 to reduce or prevent the heated air being expelled from the exhaust vent 1041 from being brought into the housing 101 again via the intake vents 1026. This configuration allows the wireless charger 100 to circulate cool air into the housing 101 to cool the coil 106 and the PCB 108 while dispelling the then-heated air away from the wireless charger 100.

The coil portion 102 and the PCB portion 104 can be in fluid communication with one another so that the air flows from the intake vents 1026, across the coil 106 in the coil portion 102, across the PCB 108 in the PCB portion 104, and out of the one or more exhaust vents 1041.

In at least one example, the coil portion 102 extends along a first plane X. The first plane X can be substantially parallel with the top side 24 of the furniture component 10 so that the coil 106 is in position for wireless charging when the device is laid on top of the top side 24 of the furniture component 10. The PCB portion 104 extends along a second plane Y that extends at an angle from the first plane X. In some examples, the angle can be between about 45 degrees and about 90 degrees. Accordingly, the PCB portion 104 extends away from the coil portion 102. With such a configuration of the housing 101, the air can then flow from the intake vents 1026, across the coil 106 in the coil portion 102 along the first plane X, across the PCB 108 in the PCB portion 104 along the second plane Y, and out the exhaust vent(s) 1041. The air is then able to have adequate flow across each of the coil 106 and the PCB 108 while discharging the then-heated air out of the exhaust vent(s) 1041 a distance away from the intake vents 1026.

Referring to FIGS. 4A-5, the coil portion 102 can include at least one support portion 1022 that extend outward from the PCB portion 104 along the first plane X. For example, as illustrated in FIGS. 4A-5, the coil portion 102 includes two support portions 1022 that extend on opposing sides of the PCB portion 104. In some examples, the support portions 1022 can overhang from the PCB portion 104. In some examples, the support portions 1022 can span between the side portions 1024. The receiving component 300 includes the one or more supports 304 that correspond with the support portions 1022. The at least one support portion 1022 is operable to abut against and/or sit on top of the one or more supports 304 when the wireless charger 100 is received in the receiving component 300.

In at least one example, the support(s) 304 can allow for a specific deflection to substantially match the feel of the surrounding area of the top side 24 (e.g., the cushion 242) but still fully support the wireless charger 100. For example, the support(s) 304 can include the same material as the cushion 242 (e.g., foam, down, feathers, latex, cotton, wool, recycled materials, fibers, hulls, and/or hybrid materials). This configuration gives the wireless charger 100 the ability to move downward if pressure is applied by the user. Nesting the wireless charger 100 on the supports 304 as discussed herein instead of a wooden frame prevents the user from feeling an immovable hard plastic wireless charger 100 embedded in the furniture component 10 and also prevents breaking of the plastic housing 101. Additionally, because the material of the cushion 242 springs back when pressure is released, it allows the wireless charger 100 to spring back to its highest position, allowing for the closest connection between the wireless charger 100 and the user's device.

In at least one example, the support(s) 304 and the aperture 302 of the receiving component 300 can be configured so that the support(s) 304 receive the coil portion 102 of the housing 101 while the PCB portion 104 is received into and through the aperture 302. The receiving component 300 can receive the wireless charger 100 in a way that allows the user to unmistakably install the wireless charger 100 in the intended X, Y, and Z orientation for the wireless charger 100 to function properly and allow the intended airflow.

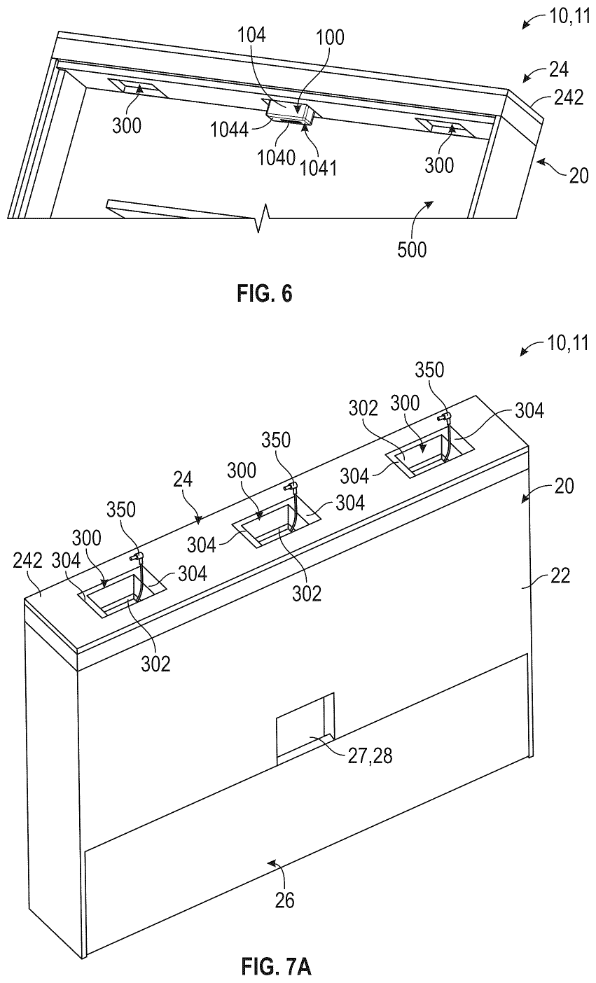

In at least one example, as illustrated in FIGS. 5 and 6, the receiving component(s) 300 can include one or more gaps 3020 between the body 20 of the furniture component 10 (e.g., the support(s) 304, the frame, etc.) and the PCB portion 104 of the wireless charger 100 so the intake vents 1026 are in fluid communication with the cavity 500. Accordingly, the intake vents 1026 can still receive cool air from the cavity 500 and allow air flow into and through the housing 101 of the wireless charger 100. Conventional wireless chargers may overheat due to being fully encapsulated in foam and/or fabric which can prevent sufficient air flow. In some examples, the sides of the receiving component 300 that includes the supports 304 may have a different shape and/or length than the sides that correspond with the side portions 1024 of the wireless charger 100 with the intake vents 1026. Accordingly, sufficient ventilation is provided by the combination of the receiving component 300 of the furniture component 10 with the configuration of the wireless charger 100.

As shown in FIGS. 5 and 6, the PCB portion 104 extends away from the top side 24 and into the cavity 500 of the furniture component 10. The exhaust vent 1041 can then be in communication with the cavity 500 of the furniture component 10. For example, the PCB portion 104 can be operable to extend past the one or more supports 304 of the furniture component 10 such that the one or more exhaust vents 1041 exhausts the air out into the cavity of the furniture component 500. Accordingly, the heated air can be exhausted from the exhaust vent 1041 directly into the cavity 500. As most of the wireless charger 100 is enclosed within furniture component 10 (e.g., the cushion 242, frame material, and/or fabric), with the configuration disclosed herein, the wireless charger 100 does not overheat and is able to sufficiently circulate cool air into the housing 101 and heated air out of the housing 101.

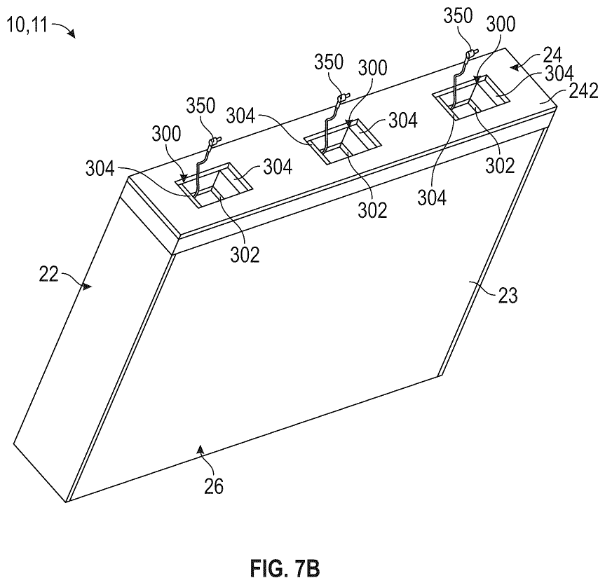

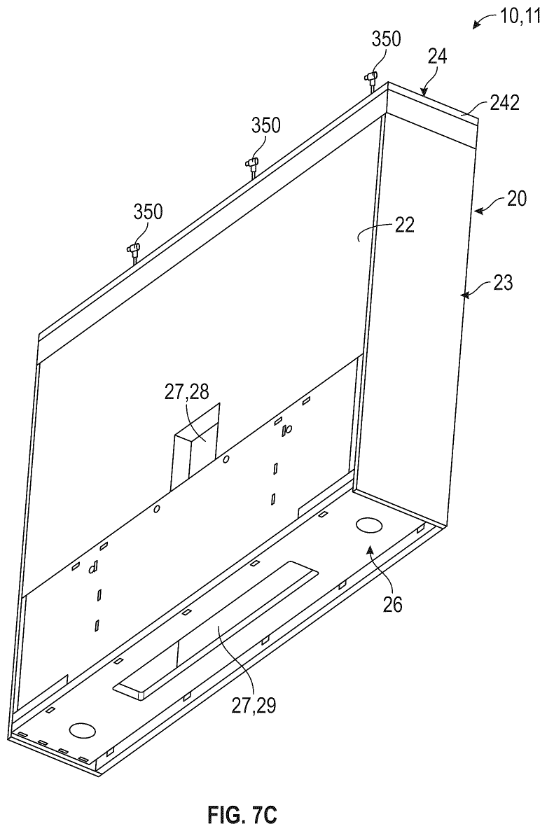

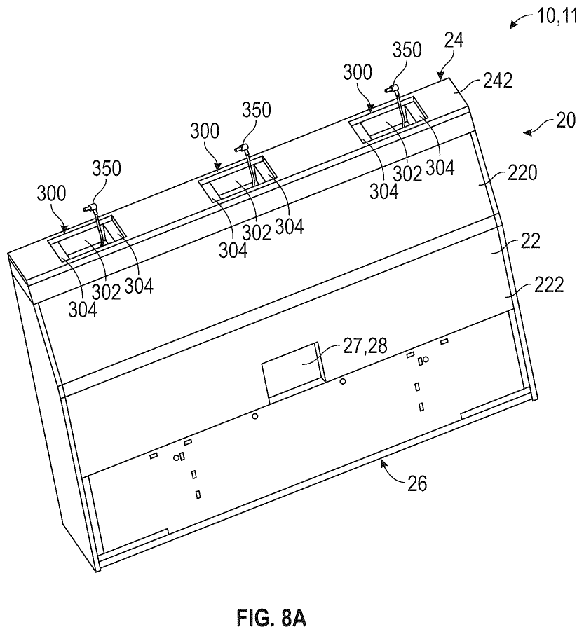

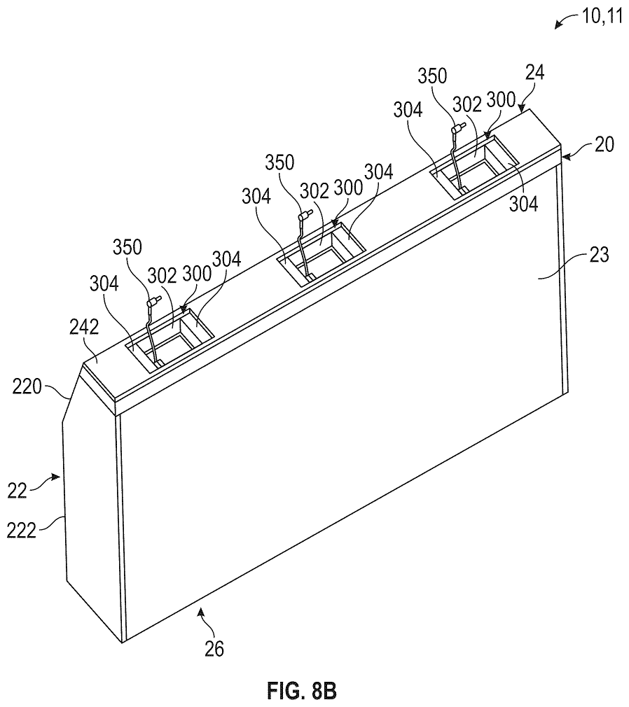

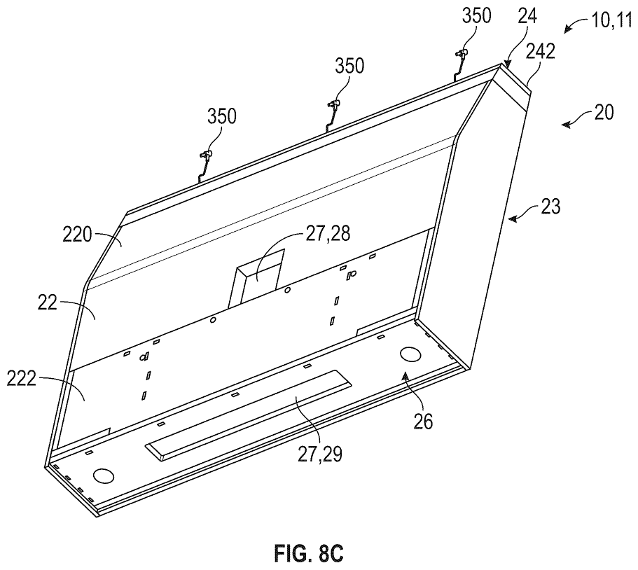

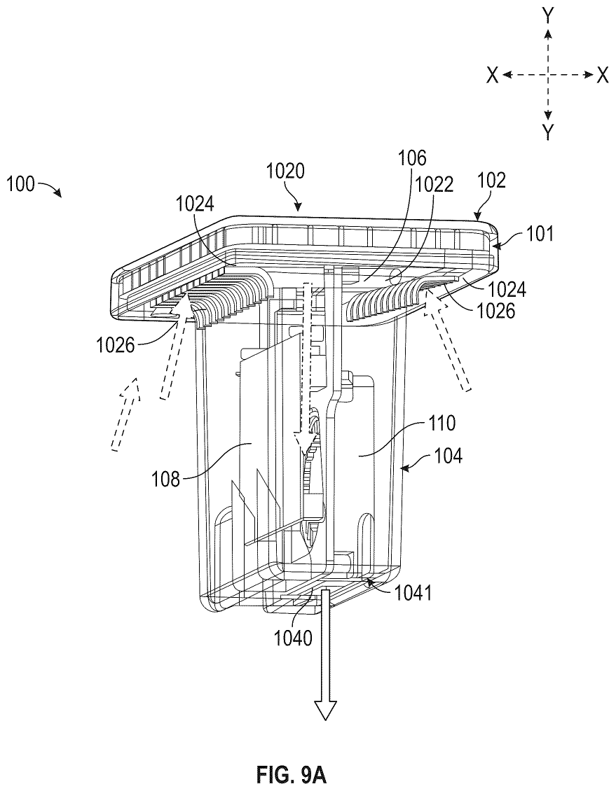

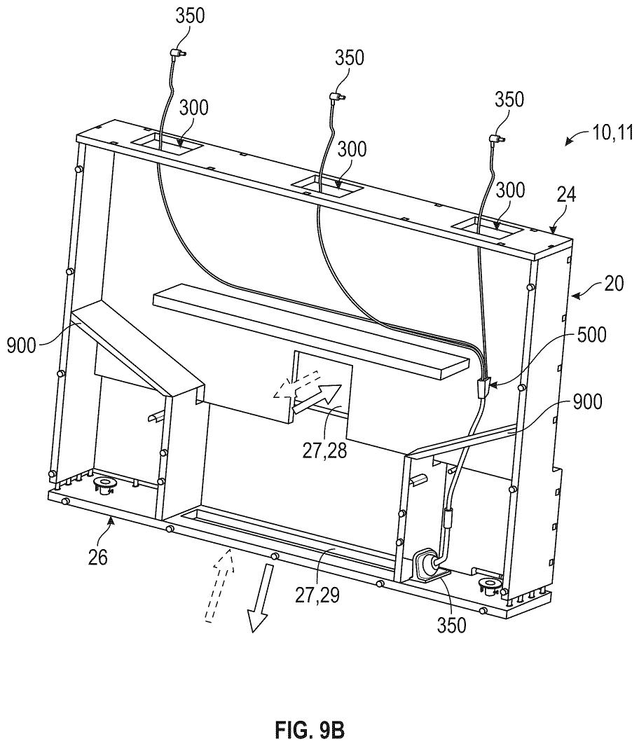

FIGS. 7A-7C and 8A-8C illustrate the furniture components 10 with differing body 20 configurations, as discussed above regarding FIGS. 1A-2B. Additionally, FIGS. 7A-8C further illustrate the receiving components 300 of the furniture component 10. In some examples, as illustrated in FIGS. 7A-8C, the access holes 27 can include one or more shoe holes 29 formed by the bottom side 26 of the body 20. As shown in FIGS. 7A-8C, the access holes 27 can be in fluid communication with the cavity 500 so that the air flows into and/or out of the access holes 27. Accordingly, as shown in FIG. 9A, cool air can enter the cavity 500 of the body 20 via the access holes 27, and the heated air can exit the cavity 500 via the access holes 27. This can ensure that the cool air enters the housing 101 of the wireless charger 100 via the intake vents 1026 to pass across the coil 106 and the PCB 108 while the heated air can be dispelled from the housing 101 via the exhaust vent(s) 1041. Meanwhile, as shown in FIG. 9B, the cavity 500 can regulate and circulate the air flow therein via the access holes 27 with the open air external to the furniture component 10.

In at least one example, as illustrated in FIG. 9B, the body 20 of the furniture component 10 can include one or more slope portions 900. The slope portions 900 can be angled from a side of the body 20 into the cavity 500. The slope portions 900 can be angled to slope downwards towards the bottom side 26 and towards the shoe hole 29. In some examples, the slope portions 900 can prevent air from getting stuck in the bottom corners of the cavity 500 to promote better air circulation. In some examples, the slope portions 900 can direct air and/or materials into the shoe hole 29, so items do not get lost within the cavity 500.

In the present disclosure, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular examples. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A wireless charger operable to be received in a furniture component, the wireless charger comprising:
a coil operable to wirelessly transfer energy to a device to charge the device;
a printed circuit board (PCB) electrically coupled with the coil;
a housing including a coil portion configured to receive the coil, and a PCB portion configured to receive the PCB,
wherein the coil portion includes one or more intake vents through which air flows into the housing,
wherein the PCB portion includes one or more exhaust vents through which the air flows out of the housing,
wherein the coil portion and the PCB portion are in fluid communication so that the air flows from the one or more intake vents, across the coil in the coil portion, across the PCB in the PCB portion, and out of the one or more exhaust vents.

2. The wireless charger of claim 1, wherein the coil portion extends along a first plane, wherein the PCB portion extends along a second plane that is extends at an angle from the first plane.

3. The wireless charger of claim 2, wherein the coil extends along the first plane, and the PCB extends along the second plane.

4. The wireless charger of claim 2, wherein the angle is between about 45 degrees and about 90 degrees.

5. The wireless charger of claim 2, wherein the coil portion includes at least one support portion that extends outward from the PCB portion along the first plane, wherein the at least one support portion is operable to abut against one or more supports of the furniture component.

6. The wireless charger of claim 5, wherein the PCB portion is operable to extend past the one or more supports of the furniture component such that the one or more exhaust vents exhausts the air out into a cavity of the furniture component.

7. The wireless charger of claim 2, wherein the coil portion includes at least one side portion that extends outward from the PCB portion along the first plane, wherein the at least one side portion forms the one or more intake vents.

8. The wireless charger of claim 1, further comprising a fan operable to draw the air into the one or more intake vents.

9. The wireless charger of claim 1, wherein the one or more exhaust vents are formed in a bottom surface of the PCB portion, wherein the bottom surface is opposite the coil portion.

10. A furniture component comprising:
a body forming a cavity and one or more access holes in fluid communication with the cavity, wherein the body includes one or more receiving components;
a power source; and
a wireless charger operable to be received in the one or more receiving components and coupled with the power source, the wireless charger including:
a coil operable to wirelessly transfer energy to a device to charge the device;
a printed circuit board (PCB) electrically coupled with the coil;
a housing including a coil portion configured to receive the coil, and a PCB portion configured to receive the PCB,
wherein the coil portion includes one or more intake vents through which air flows into the housing,
wherein the PCB portion includes one or more exhaust vents through which the air flows out of the housing,
wherein the coil portion and the PCB portion are in fluid communication so that the air flows from the one or more intake vents, across the coil in the coil portion, across the PCB in the PCB portion, and out of the one or more exhaust vents.

11. The furniture component of claim 10, wherein the coil portion extends along a first plane, wherein the PCB portion extends along a second plane that extends at an angle from the first plane.

12. The furniture component of claim 11, wherein the angle is between about 45 degrees and about 90 degrees.

13. The furniture component of claim 11, wherein each of the one or more receiving components includes one or more supports, wherein the coil portion includes at least one support portion that extends outward from the PCB portion along the first plane, wherein the at least one support portion is operable to abut against the one or more supports.

14. The furniture component of claim 13, wherein the one or more supports includes foam.

15. The wireless charger of claim 13, wherein the PCB portion is operable to extend past the one or more supports of the furniture component such that the one or more exhaust vents exhausts the air out into the cavity of the furniture component.

16. The furniture component of claim 15, wherein the one or more access holes are in fluid communication with the cavity so that the air flows into and/or out of the one or more access holes.

17. The furniture component of claim 11, wherein the coil portion includes at least one side portion that extends outward from the PCB portion along the first plane, wherein the at least one side portion forms the one or more intake vents.

18. The furniture component of claim 10, further comprising a fan operable to draw the air into the one or more intake vents.

19. The furniture component of claim 10, wherein the one or more exhaust vents are formed in a bottom surface of the PCB portion, wherein the bottom surface is opposite the coil portion.

20. The furniture component of claim 10, further comprising a top flap operable to cover the one or more receiving components and the wireless charger, wherein the top flap is separable to reveal the one or more receiving components and the wireless charger.

21. The furniture component of claim 20, wherein the top flap is water-resistant.

22. The furniture component of claim 10, wherein the one or more receiving components includes one or more gaps between the body and the PCB portion of the wireless charger so the one or more intake vents is in fluid communication with the cavity.

23. The furniture component of claim 10, wherein each of the one or more receiving components is operable to receive a filler in place of the wireless charger.

24. The furniture component of claim 23, wherein the filler includes a first layer and a second layer positioned underneath the first layer.

25. The furniture component of claim 24, wherein the first layer includes foam, and the second layer includes nylon.

26. A furniture assembly comprising:
a furniture component including a body having an internal side disposed opposite an external side, each of the internal side and the external side extending along a length between a first side and a second side;
a bottom side of the furniture component disposed opposite a top side, each of the first side and the second side extending along a height between the bottom side and the top side;
a region hidden in the body and configured to receive an electronic device; and
a flap covering the at least one region.

27. The furniture assembly of claim 26, wherein the region is one of a plurality of regions disposed along at least one of the length or the height of the body.

28. The furniture assembly of claim 26, further comprising:
a filler receivable into the region upon removal of the electronic device.

29. The furniture assembly of claim 26, further comprising:
a cavity within an interior of the body, the cavity configured to regulate a temperature of at least one of the region or the electronic device by circulating airflow.

30. The furniture assembly of claim 26, wherein the electronic device is a wireless charger configured to provide power wirelessly to a second electronic device through the flap.
